(19) United States
(12) Patent Application Publication
(10) Pub. No.: US 2023/0230039 A1
(43) Pub. Date: Jul. 20, 2023

(54) METHOD AND SYSTEM FOR PROJECT ASSESSMENT SCORING AND SOFTWARE ANALYSIS

(71) Applicants: Wes Winham Winter, Indianapolis, IN (US); Kyle Shipley, Fishers, IN (US); Anthony Panozzo, Fishers, IN (US); WOVEN TEAMS, INC., Indianapolis, IN (US)

(72) Inventors: Wes Winham Winler, Indianapolis, IN (US); Kyle Shipley, Fishers, IN (US); Anthony Panozzo, Fishers, IN (US)

(73) Assignee: WOVEN TEAMS, INC., Indianapolis, IN (US)

(21) Appl. No.: 18/002,447

(22) PCT Filed: Jun. 18, 2021
(86) PCT No.: PCT/US2021/038141

§ 371 Date: Dec. 23, 2021

Related U.S. Application Data
(60) Provisional application No. 63/041,114, filed on Jun. 18, 2020.

(51) Int. Cl. G06Q 10/1053; G06F 8/77; G06F 18/241

(52) U.S. Cl. CPC G06Q 10/1053; G06F 8/77; G06F 18/241

(57) ABSTRACT

A system for scoring and standard analysis of user responses to an assessment test, wherein the system includes a scoring engine having one or more rubric items used to score and assess a candidate’s response to one or more free-text questions. A candidate’s response can be input into the scoring engine and optionally in communication with a machine learning classifier can produce one or more outputs. The outputs can include a score, recommendation, and user feedback among other things. The system can further include one or more machine learning classifier engines.

### CROSS REFERENCE TO RELATED APPLICATION

This Patent Application claims priority to U.S. Provisional Application: 63/041,114 filed Jun. 18, 2020, the disclosure of which is considered part of the disclosure of this application and is hereby incorporated by reference in its entirety.

### FIELD OF THE INVENTION

This present disclosure relates generally to a system and method for conducting testing for potential candidates, competency testing, or certifications. In one aspect, the present disclosure relates to a method and system to test and analyze potential candidates for software engineering positions using rubric based assessments and machine learning method and system.

### BACKGROUND

Before the advent of the Internet, recruiting was done through personal recruiting where recruiters and employers would connect with individual candidates one at a time. Even since the Internet has become a widely used recruitment tool, employers have continued to contact candidates directly via in person, phone and email to assess prospective job candidates’ aptitude and abilities.

Specifically, with regards to prospective job candidates for software engineer, software engineers commonly perform take-home projects as part of interviewing for potential jobs. Then, senior engineers must take time to use their subjective expert judgement to evaluate that work. That work includes emails, documentation, Slack messages, software code, and software code comments, and more. This free text content cannot be evaluated by the techniques used for multiple choice evaluation.

Senior engineer time is expensive, so companies must have strong filters on who they allow to take these take-home projects. As a result, only job candidates who have impressive experience are allowed to complete the project. That means that job candidates who might be capable of successful completion do not get the chance. The expected value of that assessment is low for the hiring company. They will spend a lot of expert senior engineer time to find a very low number of candidates.

There exists a need to efficiently streamline the hiring and aptitude testing of prospective software engineering candidates and to provide both the employers and prospective job candidates with feedback and analysis of the respective job candidates.

### BRIEF SUMMARY OF THE INVENTION

In one aspect, this disclosure is related to a system for scoring and standard analysis of user responses to a free response assessment test, wherein the system includes a scoring engine having one or more rubric items used to score and assess a candidate’s response to one or more questions. In some exemplary embodiments, the responses can include but may not be limited to non-multiple choice free responses, such as free text responses, software responses, coding responses, command-line/terminal commands, creating system/architecture diagrams, setting up cloud systems, interacting with simulations, creating design documents, debugging, automated testing, and writing emails depending upon the project and test assessment assigned to a candidate. The assessment test itself can also include additional types of questions including but not limited to multiple choice and short form answer questions. A candidate’s response can be input into the scoring engine and the scoring engine can produce one or more outputs. The outputs can include a score, recommendation, and user feedback among other things. The system can further include one or more machine learning classifier engines. In some exemplary embodiments, the user responses are free text responses to an assessment test. Additionally, the system can provide testing on work common to the job responsibilities of a candidate, including drafting emails, documentation, Slack messages, software code, and software code comments, and more.

In another aspect, this disclosure is related to a computer-implemented method for scoring and standard analysis of user free text responses to a free-text assessment test. The method can include utilizing a scoring engine for receiving a user response to the free-text assessment test assigned to a candidate. A machine learning (“ML”) classifier engine can be used to assess one or more free text responses to the free-text assessment test. The scoring engine can designate or include one or more rubric items for which the machine learning classifier engine scores and assess a candidate’s response to one or more rubric items of the assessment test based upon the input into the scoring engine. The scoring engine can generate one or more outputs based on said candidate’s response. The outputs can include a score, hiring team recommendation, and/or candidate feedback based upon the scores generated by the scoring engine. Additionally, a score inference server including non-automated scoring can be utilized by the scoring engine in combination with the generated scores by the ML classifier engine/ML Evaluator to generate the output response. In some exemplary embodiments, the non-automated scoring can be carried out by experts or individuals with experience in the industry or scenario being tested. The non-automated scoring inputs can be utilized by the score inference server independently or in addition to the automated scores provided by the ML Classifier engine to generate feedback response and total score based upon the scenario and rubric items.

The ML Classifier engine can provides scores to one or more rubric items provided by the scoring engine. Similarly, one or more rubric items can be grouped together to generate a rubric item grouping. The rubric item grouping can be weighted an used by the score inference server to determine a final score and/or feedback. The system can further provide a human-interpretable analysis that is generated based upon the scorings of rubric items provided. The analysis can be transmitted via a network to the candidate and other user. Similarly, the analysis can be displayed upon a user interface.

The scoring engine can use a rubric item model including but not limited to pretrained language models, historical response date, or retrained language models when generating a score for a rubric item. These retained language models can further be utilized to generate new classifiers for various rubric items by the ML engine.

In yet another aspect, this disclosure is related to a system having a processing means, a computer readable memory communicatively coupled with the processing means, and a computer readable storage medium communicatively coupled with the processing means. The processing means can execute instructions stored on the computer-readable storage medium via the computer readable memory. The instructions can include initiating a scoring engine for receiving a user response to an assessment test. A machine learning classifier engine can then be initiated and utilized to assess one or more free text responses to the assessment test. The scoring engine can include one or more rubric items used to score and assess a candidate response to the assessment test. The candidate response can be input or communicated to the scoring engine and the scoring engine can generate one or more outputs based on said candidate response. The outputs can include a score and/or hiring team recommendation or candidate feedback based upon the scoring engine assessment. The ML classifier engine can be communicatively coupled to a score inference server, wherein the machine learning classifier engine scores the corresponding rubric item utilizing one or more of a linear classifiers, nearest neighbor algorithms, support vector machines, decision trees, boosted trees, or neural networks. The scoring engine can generate output responses based upon inputs from score inference server which can include non-automated scorings and the scores generated by the machine learning classifier engine. The output responses can include a candidate recommendation, a candidate feedback correspondence, or candidate comparison against a benchmark score, which can be transmitted and displayed on a user interface.

The method can further include a score inference server communicatively coupled to the scoring engine. The score inference server can be used to take a candidate response, rubric items, and generated scores (both automated and non-automated) and a rubric item of the scoring engine to predict, assign, or provide a score for the specific rubric item based upon the candidate response. The score inference server can further provide a recommendation based upon the scores. These recommendations can be an overall score as well as a pass or fail on whether the candidate should proceed to the next round of an interview, a narrative recommendation or feedback based upon the candidate’s responses and scores.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a block diagram of an exemplary embodiment of an automated score system of the present disclosure.

FIG. 2 is a diagram of an exemplary embodiment of a scoring application having a scoring engine and machine learning classifier.

FIG. 3 is a block diagram of an exemplary embodiment of a rubric item model training of the present disclosure.

FIG. 4 is a flow diagram illustrating a hiring process assessment of an exemplary embodiment of the present disclosure.

FIG. 5 is a flow diagram illustrating candidate assessment and personalized feedback to the candidate.

FIG. 6 is a flow diagram illustrating the scoring request sequence of an exemplary embodiment of the system of the present disclosure.

FIG. 7 is a flow diagram illustrating the rubric creation and reassessment for the scoring engine of the present disclosure.

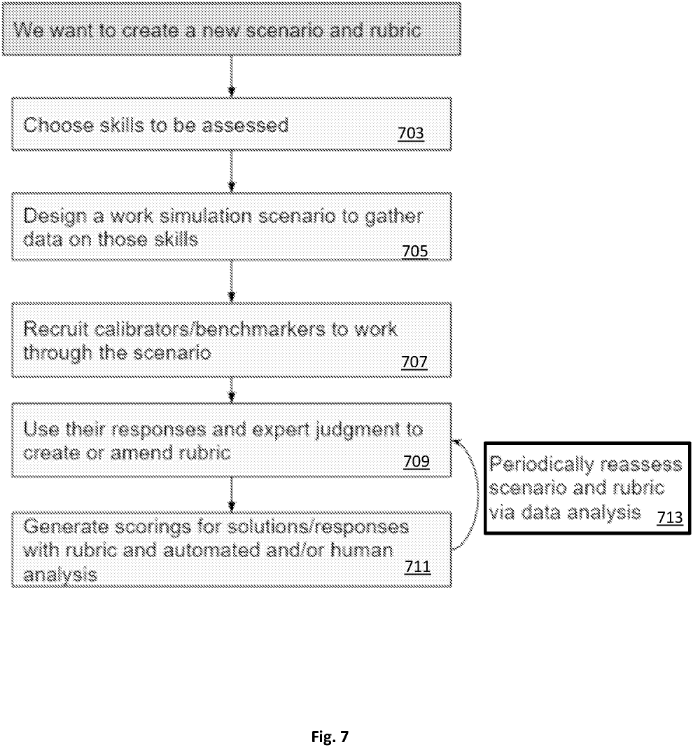

FIG. 8 is an illustration of a sample scoring interface with automated scorer.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure can provide one or more embodiments that may be, among other things, a method, system, or computer program and can therefore take the form of a hardware embodiment, software embodiment, or an embodiment combining software and hardware. In one exemplary embodiment, the present invention can include a computer-program product that can include computer-usable instruction embodied on one or more computer readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

The various components can include a communication interface. The communication interface may be an interface that can allow a component to be directly connected to any other component or allows the component to be connected to another component over network. Network can include, for example, a local area network (LAN), a wide area network (WAN), cable system, telco system, or the Internet. In an embodiment, a component can be connected to another device via a wireless communication interface through the network. Embodiments of the assessments and scoring system of the present disclosure and method may be described in the general context of a computer-executable instruction, such as program modules, being executed by a computer. Generally, program modules may include routines, programs, objects, components, data structures, among other modules., that may perform particular tasks or implement particular abstract data types. The various tasks executed in the system may be practiced by distributed computing environments where tasks are performed by remote processing devices that are linked through communications network, which may include both local and remote computer storage media including memory storage devices and data.

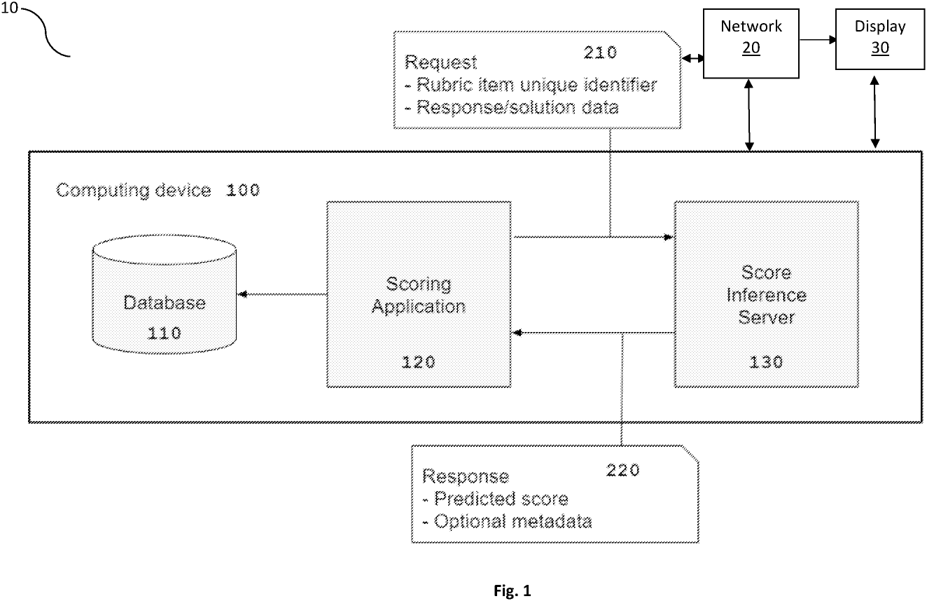

As shown in FIG. 1, the system 10 of the present disclosure can include a computing device 100 that can include a processing means that can be communicatively coupled to a database and/or computer-readable memory 110 which can be communicatively coupled to a scoring application/engine 120. The computing device 100 can be any suitable such as a computer or processing means. Additionally, in some exemplary embodiments, the scoring application 120 and be communicatively coupled to a score inference server 130. The scoring engine 120 can include one or more rubric items 310 to be analyzed for a pre-determined essay, tests, scenarios, and/or project to be assigned to a candidate. A prescribed scenario or test can include any suitable number of rubric items 310 to be scored for the scenario. In some exemplary embodiments, when initiated or requested by the scoring engine 120, the score inference server 130 component can utilize one or more scores to the scoring engine 120 for a candidate’s response. In some exemplary embodiments, an ML Classifier 240 can take a candidate response/solution 210 and rubric item 310 id, and then predict, generate, or assign a score for on or more rubric items 310. The ML Classifier 240 can utilize one or more algorithms and machine learning to score one or more rubric items 310 within a test or scenario.

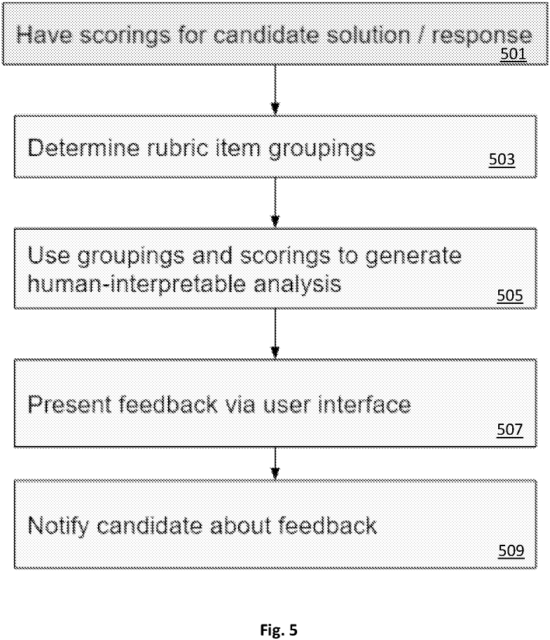

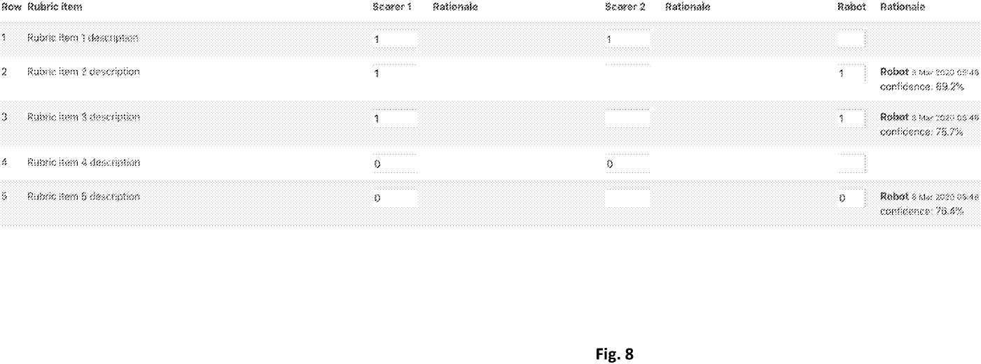

Some exemplary embodiments of the present disclosure can also utilize human or manual scoring for the various rubric items 310 of a scenario or test implemented to the candidate. The manual scoring can be used in addition to any automated scoring or similar in the place of any automated scoring by the ML Classifier 240. As shown in FIG. 8, the automated output response 220 generated by the score inference server can be displayed as a robot or automated score. The displayed score can be communicated to a user interface 30, such as a monitor or sent as an attachment to an email or message. In some embodiments, the score inference server 130 can function similar to a human/non-automated scorer and provide a score to the score engine and can be similar as the process illustrated in FIG. 5. Additionally, the score inference server 130 in some exemplary embodiments can provide a confidence score or rating on the various scores provided by the ML Classifier 240. The system 10 can further require that each rubric item 310 has at some redundancy in scoring the individual rubric items 310. In some instances where the ML Classifier 240 provides once score and a manual score input 230 may be provided that is different within a predetermined threshold or confidence level, the system 10 can require a third input or score to be made manually to provide a more consistent scoring of the rubric item 310.

A user/candidate and/or client can communicate via intermediary networks 20, such as a website or mobile app assessment platform, which can then directly communicate with the system 10. The system can send a request 210 to a candidate for the candidate to initiate a testing module/scenario that can be stored on the database 110 or external server or storage via the network 20. The computing device 100 can then initiate a testing module request 210 and the user can submit responses to the testing module and/or scenario to be scored by the system 10. A user can submit a response via a network connection to the scoring engine 120, at which point the scoring engine 120 can evaluate and assess the user’s response against one or more scoring rubric 310 items for the specified scenario or module provided by the scoring engine 120. The scoring engine 120 may also have access to a memory/database 110 that contains historical scoring responses to the same or similar questions as well as past scores and feedback based upon the historical responses. In some exemplary embodiments, unautomated and/or manual scoring can be carried out by one or more qualified scorers. Such manual scores can be further provided to the scoring engine for various rubric items 310

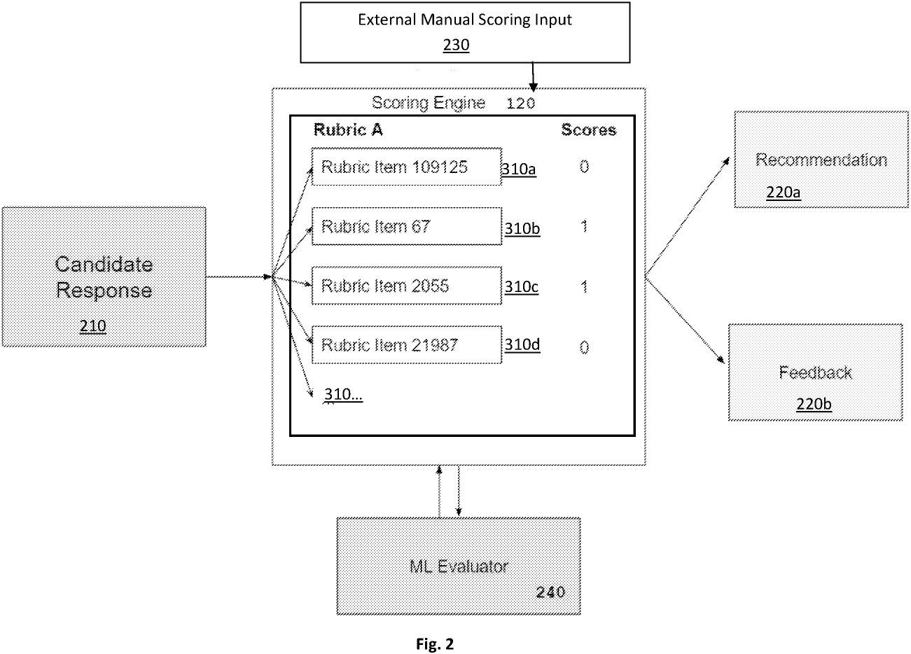

Additionally, the scoring engine/application can be communicatively coupled to a machine learning (“ML”) Classifier Engine 240 and/or scoring inference server 130. As shown in FIG. 2, the ML classifier engine 240 can take the candidate’s response from the test module response 210 to aid in generating a score to one or more rubric items 310 of the scoring engine 120. The scoring engine system 10 can generate results and/or scores for each of the rubric items 310 and send a response 220 back to the candidate and/or an employer/client, in form of feedback. The scoring engine 120 can be communicatively coupled to the ML classifier engine 240, one or more databases 110, and a score inference server 130. In some exemplary embodiments, the scoring engine 120 can include one or more rubric items 310 used to score and assess the user inputs 210. The rubric items 310 can include weights, grouping metadata by one or more categories, the ability to be scored with automated tool, and/or by one or more individual scorers. In some instances when a candidate’s response/input 210 is received the system 10 can initiate an automated and/or non-automated scoring process. When an automated scoring process is initiated, the scoring engine 120 can initiate a lookup of all rubric items 310 for one or more testing scenarios request to the candidate and request scores from the score inference server 130. Similarly, the score inference server 130 can request from the ML Classifier 240 score for particular rubric items 310 for the assigned scenarios. The score inference server 130 may also request and/or provide a confidence assessment for the assigned scores as well to determine if additional scoring inputs may be required by the scoring engine 120. For example, the score inference server 130 can assign a confidence percentage to a score provided on a rubric item as to the certainty that the score provided is the correct score. In some exemplary embodiments, the ML Classifier 240 can be communicatively coupled to a scoring inference server 130. The scoring inference server 130 can access and/or communicate with the ML Classifier 240 after receiving a request for scoring one or more rubric items 310. The scoring inference server 130 can then identify the ML Classifier 240 for the one or more rubric items 310 corresponding to a candidate’s response 210 and send the required rubric information and aggregated and/or final score to the scoring engine 120. The scoring engine 120 can then utilize the provided information, including but not limited to metadata around the accuracy of the scoring prediction/score and store it to a scoring database 110 or memory of the system 10. The scoring engine 120 can use the data around the score to determine whether or not to store the score in the database 110 for future reference by the scoring engine 120. The scoring engine 120 can make a determination based upon a pre-determined accuracy threshold in determining whether to store the scoring information and data in the database 110 and how such scoring information may be utilized for future scoring of identical rubric items 310.

Additionally, the ML classifier engine 240 can include one or more algorithms used to score and/or assess a candidate input and a system output. The algorithms can include one or more types, including by not limited to linear classifiers, nearest neighbor algorithms, support vector machines, decision trees, boosted trees, neural networks, among others. In some exemplary embodiments, the scoring engine 120 can request automated scores from the ML classifier system 240 via APIs. The ML classifier engine 240 can use various data when assessing and scoring the rubric items 310, including but not limited to previously scored rubric items 310 stored in the database 110, pretrained language models, retrained domain-specific language models, and/or a combination of the above.

In some exemplary embodiments, the scoring engine 120 can dictate which rubric items 310 to score and or which scenario to be assigned to a candidate. Based upon the scores generated and the input provided by the scoring inference server 130, the scoring engine can generate automated feedback responses and/or recommendations based upon the candidate responses.

One or more testing questions of the testing module request 210 can first be generated by a client or user and crafted to test desired skills and aptitudes of candidates for a particular job or employment position. The client/user can then create one or more scenarios, simulations, assessments, or projects that include the questions or scenarios to assess the candidate’s aptitude and abilities for the proposed position. One or more rubric items 310 can then be established based on each of the questions and/or scenarios established. The system can then include a benchmarking process where the work simulation/scenario is conducted, and the one or more rubrics items 310 can be calibrated and establish scoring bands. In some exemplary embodiments, the simulation can be taken by one or more persons who have experience in the role or the skills/experience that are related to the role for which the benchmarking process and scoring rubric is being established.

A scoring band response 220 provided by the scoring engine 120 to candidates or users can include assessments such as ready; not ready, time limits, and content validity, among other aspects. Similarly, in some exemplary embodiments the rubric items 310 may be assessed as a simple pass fail represented by a 1 (pass) or 0 (fail). In some exemplary embodiments, the testing scenarios/simulations can be similar to real-world tasks and one or more rubric items 310 can have a count or a non-binary scoring scale (i.e. scale from 0-3) wherein each scale have a general guideline or threshold established by the scoring simulation of the system. The baseline and non-binary scoring scale can be established using one or more different manners or a combination. In some exemplary embodiments, the scale can be established utilizing previously scored simulations stored on a database 110 by a non-automated/human scorer input 230 and/or in combination with an automated scoring engine 120. The score inference server 130 can be trained based upon one or more non-automated/human scorer scorings so the resulting scoring would fit into feedback outputs. In some exemplary embodiments, the scoring can provide both numerical and free text feedback such as “0 - has many unclear sentences, grammatical mistakes, or is fewer than 2 sentences” “1 - some unclear sentences but overall structure is clear” “2 - clear sentences and writing structure”. The free text feedback can be communicated back to a user for further analysis when determining the candidate’s response 220. In some exemplary embodiments, the free text feedback can be communicated to both the user and/or the candidate.

A candidate can access the system via a network 20 through any suitable means, including but not limited to email, applicant tracking system (ATS) integration with a client’s website, or an application portal to allow the candidates to participate in using the system and completing one of the work simulations or scenarios. After the candidate has completed the simulation/assessment, the system can then analyze the candidate’s inputs 210 to the questions and simulations. The system 10 can generate various outputs 220 that can then be transmitted to the client and/or user. The outputs can include but are not limited to feedback 220b provided to the candidate based upon the scoring of the rubric items of a tested scenario, as well as a recommendation 220a or exam summary to a user (i.e. potentially employer, testing facility, etc.). The candidate response 220 can include candidates for new hires, employee benchmarks for potential promotion of existing employees, or any other users that may be using the system.

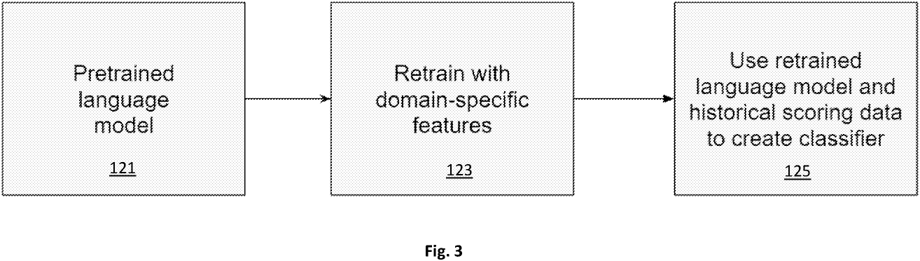

As shown in FIG. 3, the scoring engine 120 can use a rubric item model which can use data including but not limited to one or more pretrained language models, other training models, and/or historical response data and/or scores to better train and evaluate, reassess, and or create new classifiers within the ML engine 240. In some embodiments, the scoring engine rubric items 310 can initially rely only upon a pretrained language model (Step 121). This language model can then be retrained with domain-specific items or features to score the rubric items more accurately (Step 123). The retrained language model can then additionally use historical scoring data to create a classifier to be used by the ML engine (Step 125). This may then change the ML classifiers 240 in real time based on responses from the candidates or may require the ML classifiers to be retrained after a period of time and certain number of scores are obtained for a prescribed rubric item 310. In some exemplary embodiments, the rubric items 310 models may remain static, however, in other embodiments the rubric items 310 may be changed or altered by the ML engine 240 based upon the model training of the scoring engine 120.

In some exemplary embodiments, one or more rubric items 310 can include code error check and analysis. One or more rubric items 310 can be used to assess the code quality and accuracy, such as a code quality tool, linter, code analysis tool. In some exemplary embodiments, ML Classifier 240 can initially be trained by one or more algorithms that utilize past human scoring inputs on the various rubric items 310. Similarly, the ML Classifier 240 can be re-trained based upon scoring history and additional feedback or human/manual score for various rubric items 310. Additionally, when a confidence assessment score is low or there is a disagreement between the automated score by the ML Classifier 240 and a manually scored rubric item 310, the ML Classifier 240 can further be trained based upon a third manual input. Similarly, in such an instance, the scoring engine may require an additional input to score the rubric item 310. The ML Classifier 240 can further utilize a confusion matrix based upon discrepancies between human/manual scores and the ML Classifier 240 scores.

In some exemplary embodiments, the system 10 can utilize user-graded feedback and rubric scoring by one or more individuals. Additionally, other exemplary embodiments can utilize one or more automated feedback/scoring engines 120 to provide a score on one or more of the rubric items 310. The individual feedback and scoring of candidates can be implemented for new testing modules and/or scenarios until enough testing modules have been scored to implement an accurate classifier by the ML engine 240. The various rubric items 310 can be weighted in various manners. In some embodiments, the rubric items 310 can be weighted to inform a user how much a given rubric item will count toward a testing module total score by the score inference server 130. In addition to or alternatively, a per-work-simulation scenario of a testing module of the scoring engine 120 can weigh how much a given rubric item 310 counts toward the total score.

The candidate inputs and system outputs can be human-readable and can be generated by the system 10 after being processed by the scoring engine 120. The outputs can include a total score based on a predetermined amount of points possible. Similarly, another output 220 can consist of a recommendation whether to hire or pass the candidate to the next phase of the hiring process. Additionally, the outputs can comprise user feedback that can be provided to the job candidate to provide a detail as to how their answers were scored and what was acceptable or incorrect in the responses in natural language. The outputs can be communicated to the user and/or clients using any acceptable medium, including through a graphical user interface or display 30, or transmitted via a network 20 (i.e. email, messenger systems, such as Slack, text message, applicant-tracking systems, or other form of communication) to a user and displayed. In some embodiments, the generated output feedback 220 and the ML Classifiers 240 can continually be used to further tighten rubric item 310 definitions to further refine the scoring and outputs provided by an exemplary embodiment of the system. The scoring engine 120 can utilize a variety of inputs and grading methods to provide a response and score for the various rubric items 310. These inputs including but not limited to include human user or manual grading inputs, automated unit tests, ML classifiers 240, code/language parsers/tokenizers, and static code analyzers among other things. In some exemplary embodiments, a external manual score input 230 can be provided to the scoring engine for one or more rubric items 310.

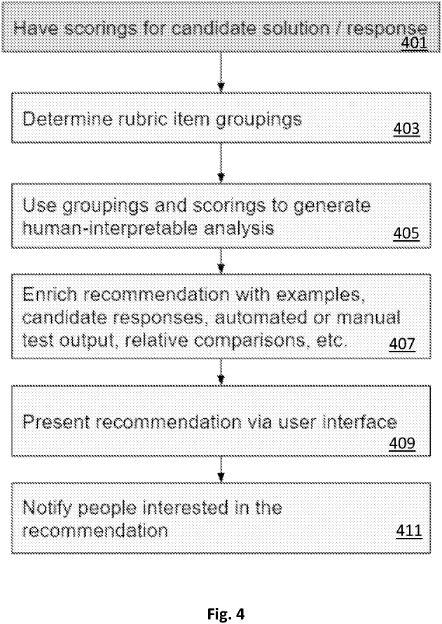

As illustrated in FIG. 4, after the system 10 can have established scores for the rubric items 310, the system can then determine groupings for each of the rubric items 310 (Step 403). In some exemplary embodiments, the scoring engine 120 can determine the groupings of the various rubric items 310. The rubric item groupings and scores can then be used to generate human-interpretable analysis (Step 405). The provided analysis feedback 220 can be further strengthened and enriched by providing examples, ideal candidate responses, automated or manual test outputs, and relative comparisons among others (Step 407). The recommendation 220 generated by the system 10 can then be displayed to a user, such as the hiring manager using via a user interface, such as a graphic display (Step 409). In some exemplary embodiments, the recommendation and feedback sent to a client/user can be generated based upon the scores of the assessment. The feedback can be automated and in free text/response form as well. Additionally, the system can further notify people interested in the recommendation (Step 411). Similarly, the system can rank one or more candidates and or provide a percentile ranking against benchmarks established by the system. In some embodiments, percentiles can be displayed by the system to users to indicate the quality of the potential candidate.

Similarly, FIG. 5 illustrates the method in which the system can provide candidate feedback to users or potential employers looking for candidates for positions. After the scoring engine 120 has established scores for each rubric item 310 (Step 501) the system can determine rubric item groupings (Step 503). The groupings and scores can then be used to generate human-interpretable analysis and feedback (Step 505). The feedback can then be presented to the candidate via user interface (Step 507). In some exemplary embodiments, the system can also notify the user using any suitable means such as an email, text message or automated phone call to notify the candidate about the feedback (Step 509). In some exemplary embodiments, the system can generate an email or correspondence to a candidate providing a text-based analysis and feedback to the candidate based upon the scoring of their responses.

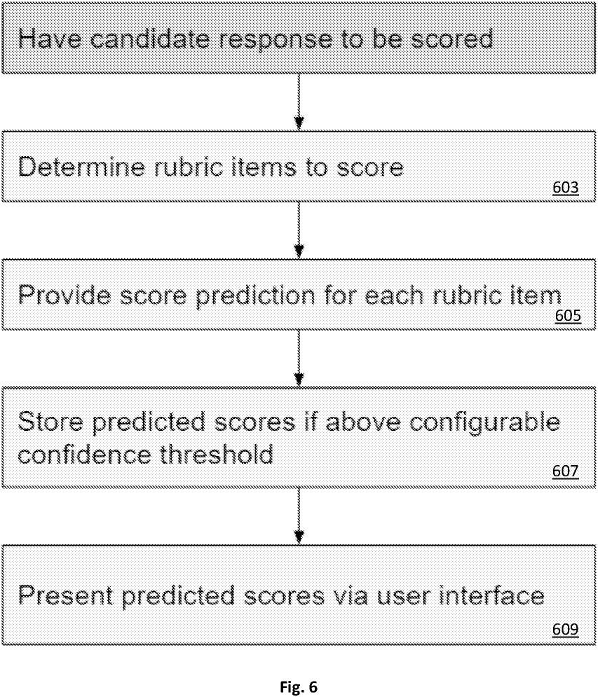

FIG. 6 provides a scoring request method for providing a predicted score of the one or more of the rubric items 310. The system can first determine the rubric items to score (Step 603). A score prediction for each rubric item can then be provided (Step 605). The predicted scores can then be stored if they are determined by the system 10 to be above a predetermined confidence threshold (Step 607). The predicted scores can then be displayed via a user interface 30 (Step 609) or sent to a user.

The system of the present disclosure can also generate one or more new scenarios or assessment tests requests 210 for potential candidates. A user or the system can determine a skill to be assessed (Step 703). The system can then generate a work simulation scenario module to gather data on the specified skills (Step 705). The system 10 can then send out correspondence to collaborators or creators stored in the database to provide benchmarks and work through the scenario to generate appropriate responses to be used as an assessment standard (Step 707). The rubric item 310 and or response scores can then be modified based upon the benchmark responses (Step 709). The system can then utilize the amended rubric and historical testing data to generate scores based upon candidate responses (Step 711). The system can then utilize these responses and scoring to periodically reassess the scenario and rubric model (Step 713).

As shown in FIG. 8, the system can provide both automated and human scored results. In some exemplary embodiments, the system can have a pre-determined confidence or confirmation threshold. For example, if a single human score matches the automated generated score, then a third scoring from an additional human scorer would not be required by the system. Alternatively, if the automated scorer and human scorer differed, a second user input scorer would be required. Additionally, the system and scoring engine 120 can provide a confidence level associated with the automated scorer results.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer-implemented method for scoring and standard analysis of user free text responses to a free-text assessment test, comprising:
providing scoring engine for receiving a user response input to the free-text assessment test assigned to a candidate;
determining whether to provide an automated or non-automated scoring response, wherein the automated scoring response comprises:
utilizing a machine learning classifier engine configured to assess one or more free text response inputs to the free-text assessment test by a user;
wherein the scoring engine includes one or more rubric items for each free-text assessment test assigned to the candidate for which the machine learning classifier engine scores and assess a candidate’s response to one or more response inputs into the scoring engine;
wherein the scoring engine generates one or more outputs based on said candidate’s response;
wherein the outputs can include at least one of the following: a score, recommendation, or user feedback based upon the scores generated by the scoring engine,
wherein the output is communicated to the user and a third party.

2. The method of claim 1, further comprising:
providing a score inference server, wherein the score inference server can utilize at least one of the following to make recommendations or feedback to a candidate response: one or more manual scores generated for one or more rubric item or one or more automated scores generated by the ML Classifier for one or more rubric items.

3. The method of claim 2, wherein the scoring engine can include a plurality of rubric Items used to analyze various components of the candidate response, wherein the machine learning classifier engine can score each of the plurality of rubric items, wherein the scoring engine requires each rubric item to have at least one manual score input and one score input generated by the ML Classifier.

4. The method of claim 3, wherein the scoring engine generates a response to the candidate based upon the generated scores of the plurality of rubric items.

5. The method of claim 4, wherein the scoring engine determine a first grouping of a plurality of rubric items are grouped together to generate a human interpretable analysis output.

6. The method of claim 5, wherein a human-interpretable analysis output can be further modified to include at least one of the following: examples, ideal candidate responses, automated or manual test outputs, and relative comparisons from historical response data.

7. The method of claim 4, wherein the scoring engine generates a recommendation to an employer based upon the generated scores of the plurality of rubric items.

8. The method of claim 5, wherein the scoring engine can use a rubric item model for generating a score comprising of at least one of the following:
pretrained models, historical response data, or retrained language models.

9. The method of claim 6, wherein the retrained language models are utilized to generate new classifiers for the various rubric items by the ML engine.

10. A system comprising:
a processing means;
a computer readable memory communicatively coupled with the processing means;
a computer readable storage medium communicatively coupled with the processing means; wherein the processing means executes instructions stored on the computer-readable storage medium via the computer readable memory and thereby:
initiating a scoring engine for receiving a user response to an assessment test;
determining to generate and automated or non-automated scoring process, wherein the automated scoring process comprises:
a machine learning classifier engine configured to assess one or more free text responses the assessment test;
wherein the scoring engine includes one or more rubric items used to score and assess a candidate response to the assessment test,
wherein the candidate response is input into the scoring engine;
wherein the scoring engine generates one or more outputs based on said candidate response. wherein the outputs can include at least one of the following: a score, recommendation or user feedback based upon the scoring engine assessment.

11. The system of claim 10, further comprising a score inference server for generating an output response, wherein the output is communicated to the user and a third party.

12. The system of claim 11, wherein the machine learning classifier engine is communicatively coupled to the score inference server, wherein the machine learning classifier engine scores the corresponding rubric item utilizing one or more of the following:
linear classifiers, nearest neighbor algorithms, support vector machines, decision trees, boosted trees, or neural networks.

13. The system of claim 12, wherein scoring engine generates the output response based upon inputs from the score inference server includes non-automated scorings and the scores generated by the machine learning classifier engine.

14. The system of claim 13, wherein the output response can include at least one of the following:
a candidate recommendation, a candidate feedback correspondence, or candidate comparison against a benchmark score.

15. The system of claim 14, wherein the output response is displayed on a user interface or sent via a network.

16. The system of claim 15, wherein the machine learning classifier engine can assign a machine learning classifier to each rubric item.

17. The system of claim 16, wherein the machine learning classifier can be initially based upon a pretrained language model.

18. The system of claim 17, wherein the machine learning classifier assigned to a rubric item can be retrained based upon historic scoring data stored in the database when determining the score for a rubric item.

19. The system of claim 18, wherein the machine learning classifiers can be updated in real time based upon responses from candidates and scores generated by the system.
